(19) United States
(12) Patent Application Publication
(10) Pub. No.: US 2004/0209155 A1
(43) Pub. Date: Oct. 21, 2004

(54) Fuel cell, electrolyte membrane-electrode assembly for fuel cell and manufacturing method thereof

(76) Inventors: Shinya Kosako, Kobe-shi (JP); Makoto Uchida, Hirakata-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/760,559

(22) Filed: Jan. 21, 2004

Related U.S. Application Data
(63) Continuation of application No. PCT/JP03/03479, filed on Mar. 20, 2003.

(30) Foreign Application Priority Data
Mar. 25, 2002 (JP) 2002-084375
Aug. 6, 2002 (JP) 2002-228319

(51) Int. Cl. H01M 4/94; H01M 8/10; H01M 4/88; B05D 5/12

(52) U.S. Cl. 429/44; 429/30; 429/42; 427/115; 502/101

(57) ABSTRACT

An electrolyte membrane-electrode assembly for a fuel cell includes a polymer electrolyte membrane and a pair of electrodes sandwiching the electrolyte membrane. Each of the electrodes includes a catalyst layer in contact with the polymer electrolyte membrane and a gas diffusion layer in contact with the catalyst layer, and the polymer electrolyte membrane includes electronically insulating particles, which serve as spacers for separating the gas diffusion layers of the electrodes, in a region sandwiched between the electrodes.

This application is a continuation of PCT/JP03/03479 filed Mar. 20, 2003.

### FIELD OF THE INVENTION

The present invention relates to a polymer electrolyte fuel cell, particularly to an electrolyte membrane-electrode assembly and a manufacturing method thereof.

### RELATED ART

A polymer electrolyte fuel cell converts chemical energy into electric energy and heat by electrochemically reacting fuel gas, such as hydrogen, with an oxidant gas containing oxygen, such as air. An example of an electrolyte membrane-electrode assembly (MEA) constituting the power generating element of a fuel cell is illustrated in FIG. 12A. An anode-side catalyst layer 94 and a cathode-side catalyst layer 96 are provided on both sides of a polymer electrolyte membrane 91 that selectively transports protons in a manner such that they are in close contact with the membrane. Catalyst layers 94 and 96 comprise a carbon powder carrying a platinum group metal catalyst and a proton-conductive polymer electrolyte.

An anode-side gas diffusion layer 93 and a cathode-side gas diffusion layer 95 having gas permeability and electronic conductivity are provided on the outer faces of the catalyst layers 94 and 96, respectively, in a manner such that they are in close contact with each other. The gas diffusion layers 93 and 95 are normally made of a gas-permeable conductive material, which is obtained by treating, for example, carbon paper or carbon cloth to make it water-repellent.

The MEA is sandwiched between a separator plate having a gas flow channel for supplying the fuel gas to the anode and a separator plate having a gas flow channel for supplying the oxidant gas to the cathode, to constitute a unit cell. In order to prevent the fuel gas and the oxidant gas from leaking outside and mixing together, gas sealing materials or gaskets are arranged around the gas diffusion layers so as to sandwich the polymer electrolyte membrane.

Hydrogen gas, which reaches the anode-side catalyst layer through the gas diffusion layer of the anode, generates protons and electrons over the catalyst by the chemical reaction expressed in the following formula (1). The protons diffuse through the polymer electrolyte membrane to the cathode side. In the cathode-side catalyst layer, the oxygen reacts with the protons coming from the anode to produce water, as represented by formula (2).

H₂→2H⁺+2e⁻ (1)

½O₂+2H⁺+2e⁻→H₂O (2)

As the polymer electrolyte membrane and polymer electrolyte, a membrane of perfluorocarbon sulfonic acid, which comprises a —CF₂— backbone and side chains having a sulfonic acid group (—SO₃H) on the terminal end, and a polymer electrolyte solution are generally used. Commercially available MEAs are marketed under the trade names of NAFION™ (E. I. DuPont de Nemours & Co. Inc.), FLEMION™ (Asahi Glass Co., Ltd.) and ACIPLEX™ (Asahi Chemical Industry Co., Ltd.). In such a polymer electrolyte, agglomeration of the sulfonic acids forms a conductive three-dimensional network, which serves as a proton conductive channel.

The performance of fuel cells is evaluated by the difference in potential (cell voltage) between the anode-side gas diffusion layer 93 and the cathode-side gas diffusion layer 95 when they are operated at the same current density. Since the components of the MEA are connected in series and in layers, the polymer electrolyte membrane 91, which is the layer having the highest internal resistance, significantly determines the cell voltage (i.e., the performance of the cell). Based on experiments described below, the present inventors believe that the internal resistance of the MEA is proportional to its thickness. Thus, in order to reduce the internal resistance of the MEA, or to enhance the proton conductivity, a thinner polymer electrolyte membrane is necessary.

There are two typical methods for manufacturing a conventional MEA.

According to a first manufacturing method, first, a catalyst layer is formed on each surface of a polymer electrolyte membrane, and then a gas diffusion layer is joined to each catalyst layer. This catalyst layer is formed by applying a catalyst paste, containing a polymer electrolyte and a carbon powder carrying a metal catalyst, on a substrate of a film of polypropylene, polyethylene terephthalate, polytetrafluoroethylene or the like, and drying it.

Subsequently, the catalyst layer formed on the substrate is transferred to each side of the polymer electrolyte membrane by a hot press or hot rollers. Thereafter, the substrate is peeled from the catalyst layer, so that a polymer electrolyte membrane having the catalyst layers is formed. In addition to this transfer method, the catalyst layers may be formed by a method of applying the catalyst paste onto the polymer electrolyte membrane by printing, spraying or the like, and then drying it. To these catalyst layers, a gas diffusion layer comprising carbon paper, carbon cloth or the like is thermally bonded under pressure by a hot press or hot rollers.

A second manufacturing method is as follows. A gas diffusion layer, on which a catalyst layer is formed beforehand, is placed on each side of a polymer electrolyte membrane in such a manner that the catalyst layer faces inward, and the gas diffusion layer is thermally bonded under pressure by a hot press or hot rollers. This catalyst layer is formed, for example, by a method of applying a catalyst paste onto the gas diffusion layer by a printing method or a spraying method, and drying it.

Since the gas diffusion layer is made of fibrous carbon, it is difficult to make the surface thereof completely flat and smooth, and the surface usually has a large number of small projections. This may lead to the following phenomenon: in thermo-compression bonding by a hot press or hot rollers or in fabrication of a unit cell, projections 99 on the gas diffusion layers 93 and 95 compress and penetrate the catalyst layers 94 and 96 and the polymer electrolyte membrane 91 so that the anode and the cathode come in contact with each other, as illustrated in FIG. 12B. It is extremely important to solve this problem in order to provide a polymer electrolyte fuel cell that is free from an internal short circuit.

### SUMMARY OF THE INVENTION

The present invention provides an MEA in which an anode and a cathode are reliably separated from each other to avoid internal short circuiting, the internal resistance is low, and the effective reaction surface area is large.

The present invention provides a polymer electrolyte membrane-electrode assembly for a fuel cell comprising a first electrode and a second electrode; and a polymer electrolyte membrane interposed between the first and second electrodes, wherein each of the first and second electrodes comprises a catalyst layer in contact with the polymer electrolyte membrane and a gas diffusion layer in contact with the catalyst layer, and wherein the polymer electrolyte membrane comprises electronically insulating spacer members that separate the respective gas diffusion layers of the first and second electrodes. The spacer members may comprise an electrically insulating material. The spacer members may also comprise a polymer electrolyte having a higher modulus of elasticity than a material of the polymer electrolyte membrane. The gas diffusion layer of at least one of the first and second electrodes may comprise projections on a surface that faces the polymer electrolyte membrane and an electronically insulating layer that coats the projections. The insulating layer may comprise an electrically insulating inorganic material and a polymer resin.

The present invention also provides a method for manufacturing a polymer electrolyte membrane-electrode assembly for a fuel cell, comprising the steps of disposing electronically insulating particles over a face of a polymer electrolyte membrane; providing a first electrode to the face of the polymer electrolyte membrane having the particles; and providing a second electrode to another face of the polymer electrolyte membrane.

The present invention also provides a method for manufacturing a polymer electrolyte membrane-electrode assembly for a fuel cell, comprising the steps of applying a polymer electrolyte solution onto a surface of a first polymer electrolyte membrane; disposing electronically insulating particles on the surface applied with the polymer electrolyte solution; drying the polymer electrolyte solution to form a composite polymer electrolyte membrane comprising the first polymer electrolyte membrane and a second polymer electrolyte membrane that contains the particles; applying a first electrode to one face of the composite polymer electrolyte membrane; and applying a second electrode to another face of the composite polymer electrolyte membrane.

The present invention also provides a method for manufacturing a polymer electrolyte membrane-electrode assembly for a fuel cell, comprising the steps of disposing electronically insulating particles on a face of a first polymer electrolyte membrane; layering a second polymer electrolyte membrane to the face of the first polymer electrolyte membrane having the particles to form a composite polymer electrolyte membrane; applying a first electrode to one face of the composite polymer electrolyte membrane; and applying a second electrode to another face of the composite polymer electrolyte membrane.

The present invention also provides a method for manufacturing a polymer electrolyte membrane-electrode assembly for a fuel cell, comprising the steps of applying a solution containing a multi-functional monomer capable of thermal polymerization or photo polymerization and a polymer electrolyte in an island form to a face of a first polymer electrolyte membrane; performing at least one of photo-irradiating and heating the solution applied to the face of the first polymer electrolyte membrane to form polymer electrolyte particles having a high modulus of elasticity on the first polymer electrolyte membrane; applying a polymer electrolyte solution onto the face of the first polymer electrolyte membrane having the particles; drying the applied polymer electrolyte solution to form a composite polymer electrolyte membrane comprising the first polymer electrolyte membrane and a second polymer electrolyte membrane that contains the particles; and applying a first electrode to one face of the composite polymer electrolyte membrane; and applying a second electrode to another face of the composite polymer electrolyte membrane.

The present invention also provides a polymer electrolyte membrane electrode assembly for a fuel cell, comprising a polymer electrolyte membrane; an anode-side electrode applied to a first face of the polymer electrolyte membrane; a cathode-side electrode applied to a second face of the polymer electrolyte membrane that opposes the first face; and a plurality of electronically insulating members disposed between the anode-side and cathode-side electrodes that separates the two electrodes in a region of the electronically insulating members. The anode-side and cathode-side electrodes may each comprise a catalyst layer. The electronically insulating members may comprise an electrically conductive particle coated with an electrically insulating material. The electronically insulating members comprise a polymer electrolyte material having a higher modulus of elasticity than that of the polymer electrolyte membrane. The thicknesses of the electronically insulating members may be in the range of about 5 to about 20 μm.

The present invention also provides a polymer electrolyte membrane electrode assembly, comprising a polymer electrolyte membrane; an anode-side electrode joined to a first face of the polymer electrolyte membrane; a cathode-side electrode joined to a second face of the polymer electrolyte membrane that opposes the first face; at least one of the anode-side and cathode-side electrodes comprises a gas diffusion layer having projections facing the polymer electrolyte membrane; and an electronically insulating layer that is disposed between the electrodes that separates the electrodes in a region of the electronically insulating layer and that coats the projections facing the polymer electrolyte membrane. The electronically insulating layer may comprise a polymer resin. The electronically insulating layer may further comprise inorganic insulating material. The polymer electrolyte membrane electrode assembly may further comprise a plurality of electronically insulating members that are disposed between the anode-side and cathode-side electrodes and that separate the anode-side and cathode-side electrodes in a region of the electronically insulating members. The polymer electronically insulating members may be particles which have thicknesses in a range of about 5 μm to about 20 μm.

### BRIEF DESCRIPTION OF THE DRAWINGS

FIG. 1A is a schematic longitudinal sectional view of an electrolyte membrane-electrode assembly, after thermo-compression bonding, in accordance with the present invention.

FIG. 1B is an enlarged sectional view of the main part of the electrolyte membrane-electrode assembly, after thermo-compression bonding, in accordance with the present invention.

FIG. 2A is an enlarged sectional view of the main part of an electrolyte membrane-electrode assembly, before thermo-compression bonding, in accordance with the present invention.

FIG. 2B is an enlarged sectional view of the main part of the electrolyte membrane-electrode assembly, after thermo-compression bonding, in accordance with the present invention.

FIG. 2C illustrates an electrically conductive particle coated with an electrically insulating material.

FIG. 3A is an enlarged sectional view of the main part of another electrolyte membrane-electrode assembly, before thermo-compression bonding, in accordance with the present invention.

FIG. 3B is an enlarged sectional view of the main part of the another electrolyte membrane-electrode assembly, after thermo-compression bonding, in accordance with the present invention.

FIGS. 4A and 4B are longitudinal sectional views showing manufacturing steps of an electrolyte membrane-electrode assembly according to a first manufacturing method of the present invention.

FIGS. 5A through 5E are longitudinal sectional views showing manufacturing steps of an electrolyte membrane-electrode assembly according to a second manufacturing method of the present invention.

FIGS. 6A through 6E are longitudinal sectional views showing manufacturing steps of an electrolyte membrane-electrode assembly according to a third manufacturing method of the present invention.

FIGS. 7A through 7F are longitudinal sectional views showing manufacturing steps of an electrolyte membrane-electrode assembly according to a fourth manufacturing method of the present invention.

FIG. 8 is a longitudinal sectional view of a unit cell of a fuel cell in an example of the present invention.

FIG. 9 is a sectional view of the main part of a gas diffusion layer having an electronically insulating layer that is formed on projections on the surface.

FIG. 10 is a longitudinal sectional view of an electrolyte membrane-electrode assembly in another example of the present invention.

FIG. 11 is an enlarged sectional view of a gas diffusion layer having an electronically insulating layer that is formed on projections on the surface.

FIG. 12A is a schematic longitudinal sectional view of a related art electrolyte membrane-electrode assembly after thermo-compression bonding.

FIG. 12B is an enlarged sectional view of the main part of the related art electrolyte membrane-electrode assembly after thermo-compression bonding.

FIG. 13 is a graph showing the operational characteristics of unit cells of Examples 1-3 of the present invention and Comparative Example 1.

FIG. 14 illustrates a first method of manufacturing an MEA of the present invention.

FIG. 15 illustrates a second method of manufacturing an MEA of the present invention.

FIG. 16 illustrates a third method of manufacturing an MEA of the present invention.

FIG. 17 illustrates a fourth method of manufacturing an MEA of the present invention.

FIG. 18 shows the embodiment of FIG. 10 with electronically insulating members serving as spacers.

### DETAILED DESCRIPTION OF EMBODIMENTS

An electrolyte membrane-electrode assembly (MEA) for a fuel cell in accordance with the present invention contains electronically insulating particles in the region of a polymer electrolyte membrane (PEM) sandwiched between two electrodes. The electronically insulating particles are more rigid or have a higher modulus of elasticity than the material of the polymer electrolyte.

In the present invention, the phrase “electronically insulating property” refers to having substantially no electronic conductivity. One category of electronically insulating materials is an electrically insulating material. Another category of such materials is a polymer electrolyte having proton conductivity.

The electronically insulating particles act as spacers that separate the gas diffusion layers of the anode and the cathode from each other when the polymer electrolyte membrane is compressed by the stress applied during the manufacturing process, particularly the thermo-compression bonding process of bonding the electrodes with the PEM. The particles prevent the projections on the surfaces of the gas diffusion layers from penetrating the polymer electrolyte membrane and contacting the opposing electrode. As a result, it is possible to produce a thinner MEA than is possible with conventional or related art techniques, while still reducing or eliminating the prospect of creating an internal short circuit during the thermo-compression bonding process. Because the MEA may be made thinner and its internal resistance is proportional to its thickness, the above-described method provides an MEA having low internal resistance.

That is, the electronically insulating particles intervening between the anode and the cathode perform the function of a spacer which prevents the electrodes from coming closer to each other than a certain interval. Therefore, when the PEM is compressed and softened during the thermo-compression bonding process, the particles prevent a short circuit that could otherwise be caused by the contact of the projections on the gas diffusion layer of the anode or the cathode with the gas diffusion layer of the opposing electrode.

The existence of the particles serving as the spacers in the PEM makes it possible to increase the pressure applied during the thermo-compression bonding, so that the softened polymer electrolyte can be allowed to enter the catalyst layers and the gas diffusion layers. Accordingly, the area of the three-phase interface is increased, where the reaction gas, the polymer electrolyte and the carbon carrying the catalyst coexist. As a result, it is possible to increase the effective reaction surface area (i.e., by increasing the volume of space where the reaction takes place} of the MEA and increase the operating voltage of the polymer electrolyte fuel cell comprising this MEA.

In one mode of the present invention, in the gas diffusion layer of at least one of the electrodes, the projections on the surface facing the polymer electrolyte membrane are coated with an electronically insulating layer.

The electronically insulating layer may comprise an electrically insulating inorganic material and a polymer resin.

When the projections of the gas diffusion layer are coated with the electronically insulating layer, there is decreased risk of causing an internal short circuit even if the projections come in contact with the gas diffusion layer of the other electrode.

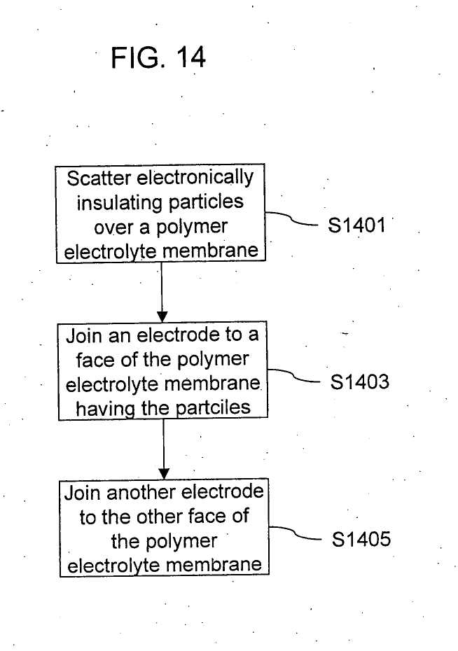

The MEA of the present invention can be manufactured by the methods illustrated in the flow charts of FIGS. 14-17.

FIG. 14 is a flow chart illustrating a first method of manufacturing an MEA of the present invention. According to this method, electronically insulating particles are scattered in Step S1401 over a polymer electrolyte membrane. One of the two electrodes is joined in Step S1403 to the face of the polymer electrolyte membrane having the particles. The other electrode is joined in Step S1405 to the other face.

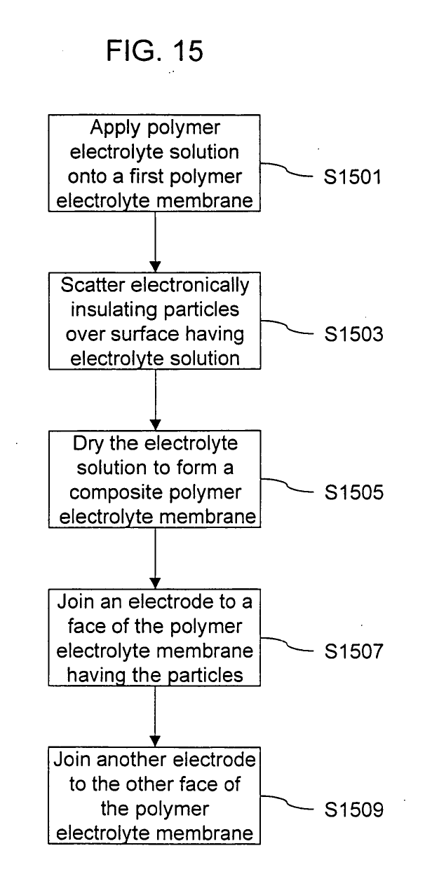

FIG. 15 is a flow chart illustrating a second method of manufacturing an MEA of the present invention. According to this method, polymer electrolyte solution is applied in Step S1501 onto a first polymer electrolyte membrane. Electronically insulating particles are scattered in Step S1503 over the surface applied with the polymer electrolyte solution. The polymer electrolyte solution is dried in Step S1505 to form a composite polymer electrolyte membrane which has a second polymer electrolyte membrane containing the particles scattered over the surface of the first polymer electrolyte membrane. One of two electrodes is joined in Step S1507 to one face of the composite polymer electrolyte membrane and the other electrode is joined in Step S1509 to the other face.

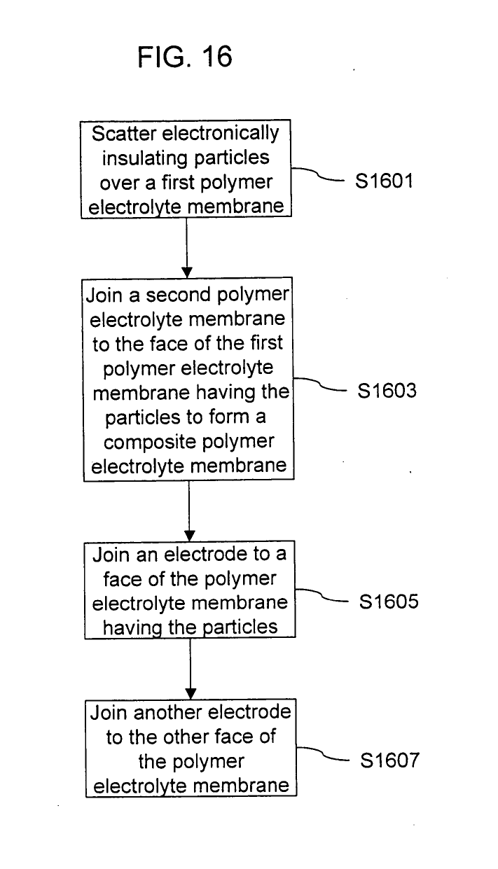

FIG. 16 is a flow chart illustrating a third method of manufacturing an MEA of the present invention. According to this method, electronically insulating particles are scattered in Step S1601 over a first polymer electrolyte membrane. A second polymer electrolyte membrane is joined in Step S1603 to the face of the first polymer electrolyte membrane, having the particles, to form a composite polymer electrolyte membrane. One of two electrodes is joined in Step S1605 to one face of the composite polymer electrolyte membrane and the other electrode is joined in Step S1607 to the other face.

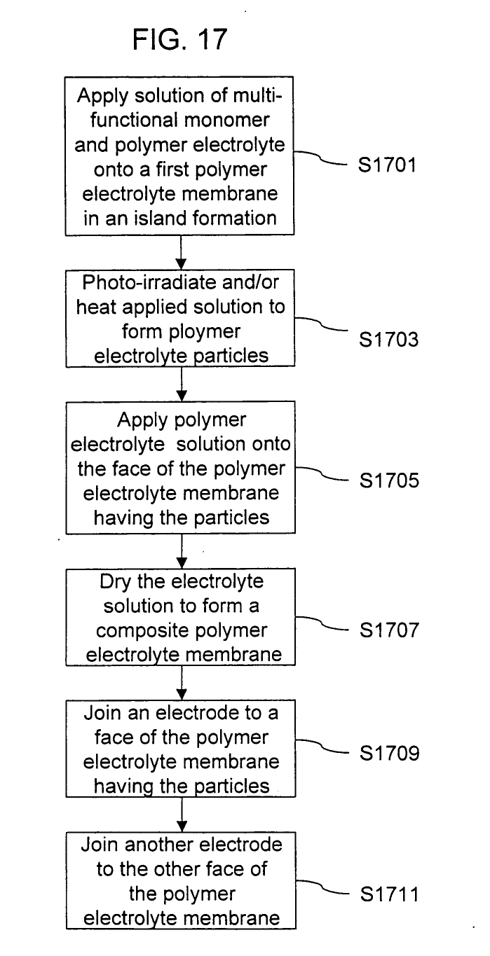

FIG. 17 is a flow chart illustrating a fourth method of manufacturing an MEA of the present invention. According to this method, a solution containing a multi-functional monomer, capable of thermal polymerization or photo polymerization, and a polymer electrolyte are applied in Step S1701 onto a first polymer electrolyte membrane in an island form. The applied solution is photo-irradiated, heated, or both photo-irradiated and heated in Step S1703 to form polymer electrolyte particles, having a high modulus of elasticity, on the first polymer electrolyte membrane. A polymer electrolyte solution is applied in Step S1705 onto the face of the first polymer electrolyte membrane having the particles. The applied polymer electrolyte solution is dried in Step S1707 to form a composite polymer electrolyte membrane having a second polymer electrolyte membrane that contains the particles. One of two electrodes is joined in Step S1709 to one face of the composite polymer electrolyte membrane and the other electrode is joined in Step S1711 to the other face.

In the respective methods described above, the step of joining the electrode to the polymer electrolyte membrane may comprise either of the following methods. One method comprises the step of joining a catalyst layer to the polymer electrolyte membrane and the step of joining a gas diffusion layer to the catalyst layer. The other method comprises the step of joining a gas diffusion layer, having a catalyst layer, to the polymer electrolyte membrane. These methods may further comprise the step of forming an electronically insulating layer on the projections on the surface of the gas diffusion layer facing the catalyst layer, before joining the gas diffusion layer to the catalyst layer.

One technique for forming the electronically insulating layer on the projections of the gas diffusion layer is a method of forming an electronically insulating layer on a substrate in advance and then transferring the electronically insulating layer to the projections of the gas diffusion layer. Another technique is a method of applying a coating material containing an electronically insulating material onto the projections of the gas diffusion layer and drying or curing it to form an electronically insulating layer.

Embodiments of the present invention are described below.

### Embodiment 1

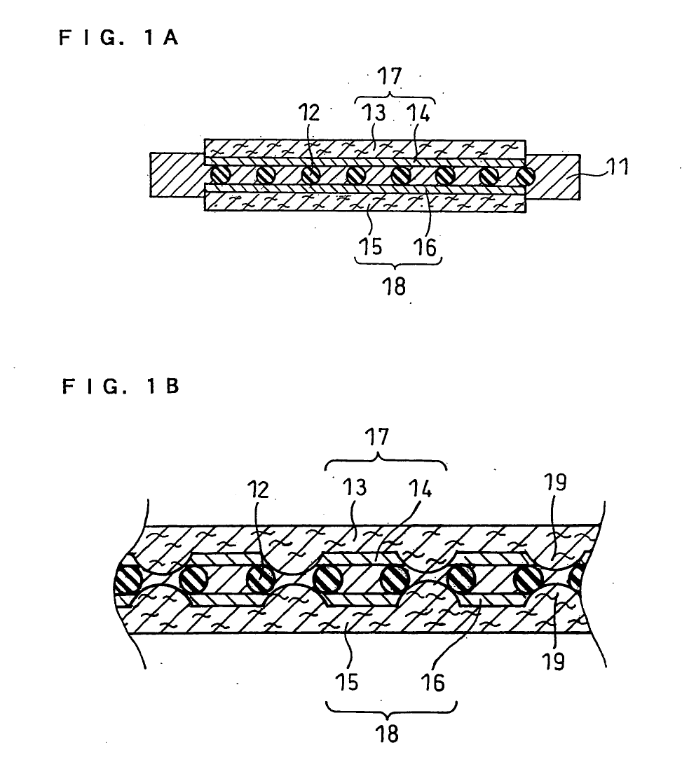

FIG. 1A and FIG. 1B illustrate an MEA of this embodiment. Electrically insulating particles 12 are dispersed in a polymer electrolyte membrane 11, and the particles 12 intervene between an anode 17 and a cathode 18 to serve as spacers between the electrodes. When gas diffusion layers 13 and 15 have projections 19 on the surfaces contacting anode-side and cathode-side catalyst layers 14 and 16, the particles 12 prevent the breakage of the polymer electrolyte membrane 11 and separate the anode 17 from the cathode 18, such that there is a certain interval between them even where they come closest to each other, as shown in the enlarged view of FIG. 1B.

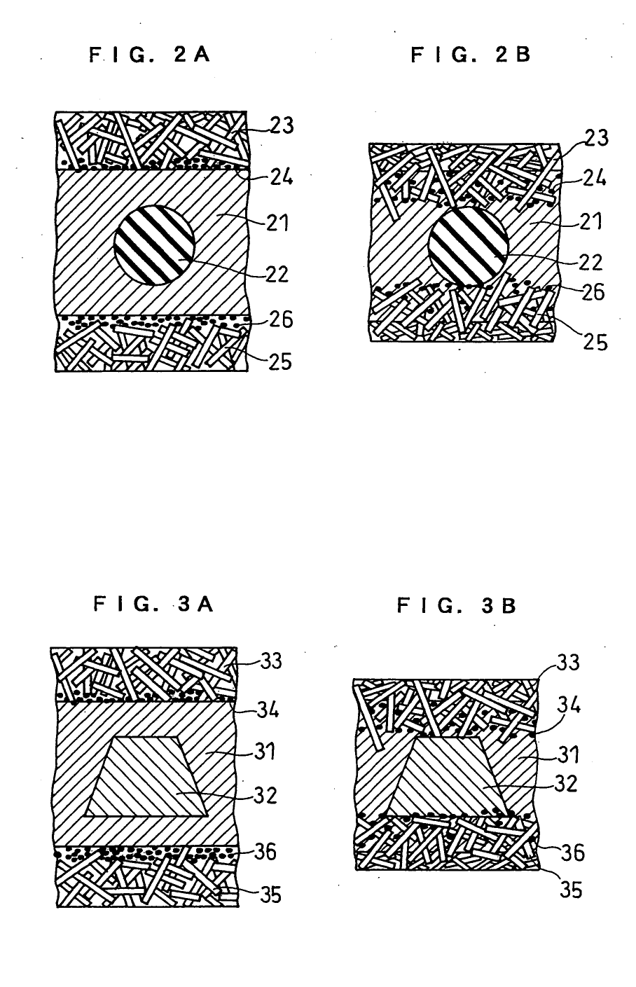

FIG. 2A and FIG. 2B are enlarged sectional views schematically showing the vicinity of the polymer electrolyte membrane and the electrodes of the MEA of FIG. 1A and FIG. 1B. FIG. 2A illustrates a state of the MEA before the thermo-compression bonding. Carbon particles 24 and 26, which carry the metal catalysts of the anode-side and cathode-side catalyst layers, exist between a polymer electrolyte membrane 21 and carbon fibers 23 and 25 constituting the anode-side and cathode-side gas diffusion layers. FIG. 2B illustrates a state of the MEA after the thermo-compression bonding. Because the polymer electrolyte membrane was heated to about the softening temperature and pressed, the polymer electrolyte membrane 21 is compressed and becomes thin, such that the carbon fibers 23 and 25 and the carbon particles 24 and 26 are close to or in contact with the particles 22.

The gas diffusion layers are made of a material such as carbon paper or carbon cloth, in which the carbon fibers 23 and 25 are entwined with one another. Thus, when heated and softened, the polymer electrolyte membrane 21 enters the gaps of the network of carbon fibers. Furthermore, since the catalyst layers are brittle, the layer structure is partially damaged upon the thermo-compression bonding, so that the carbon particles 24 and 26 are dispersed. Thus, a layer including a mixture of the dispersed carbon particles 24 and 26, the carbon fibers 23 and 25, and the polymer electrolyte membrane 21 entering between them is formed. This increases the area of the above-mentioned three-phase interface necessary for the metal catalyst to act effectively. Also, since the particles 22 function as spacers to keep the interval between the anode and the cathode constant, even if the substantial thickness of the polymer electrolyte membrane 21, which separates the electrodes, is decreased upon the thermo-compression bonding, the projections formed by the tip ends and projected parts of the carbon fibers 23 and 25 do not penetrate the polymer electrolyte membrane 21. FIG. 2A illustrates an example in which the diameter of particle 22 is less than the thickness of polymer electrolyte membrane 21. Alternatively, the diameter of particle 22 may be greater than the thickness of the polymer electrolyte membrane 21, since the particle 22 may dig slightly into the carbon fibers 23 and 25.

The size or thickness of particle 12 or 22 corresponds to the thickness of the polymer electrolyte membrane 21 after thermo-compression bonding. Thus, the preferable size or thickness of the particle is determined in view of the trade-off between the proton conductivity necessary for the polymer electrolyte membrane and the cross leak of the reaction gases. From the viewpoint of proton conductivity, the thickness of the polymer electrolyte membrane after the compression bonding is preferably about 20 microns (μm) or less. However, the cross leak of the fuel gas and the oxidant gas increases sharply when the thickness of the membrane is several μm or less. From this viewpoint, the thickness of the polymer electrolyte membrane after the compression bonding is preferably about 5 μm or more. Accordingly, the size or thickness of the particle is preferably about 5 to about 20 μm.

For particle 22 to function better as a spacer between the electrodes, it is preferable to select a material that is not susceptible to plastic deformation upon thermo-compression bonding. In other words, a material having such properties as a higher modulus of elasticity and a higher hardness than those of the polymer electrolyte, at the temperatures of the thermo-compression bonding, is preferred. As the electrically insulating material for constituting particle 12 or 22, glass, ceramic, inorganic or organic crystal, and minerals such as mica, resin, rubber, ebonite, dietary fiber, and the like may be used. It is also possible to use an electrically conductive particle of, for example, metal or carbon coated with an electrically insulating material. FIG. 2C illustrates an electrically conductive particle 22A coated with an electrically insulating material 27. The electrically insulating material may be of any type described herein or known to those skilled in the art.

Any material having a proton conductive channel, but also having an electrically insulating property, may be used as the particles 12 and 22. Examples of such materials include a proton-conductive resin whose modulus of elasticity is increased by cross-linking or the like, a cross-linked cation-exchange resin having proton conductivity, and an inorganic porous substance impregnated with a polymer electrolyte.

### Embodiment 2

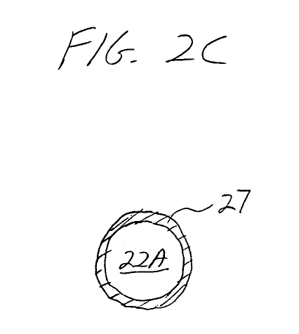

FIG. 3A and FIG. 3B are sectional views schematically showing the vicinity of a polymer electrolyte membrane and electrodes of an MEA in this embodiment. FIG. 3A illustrates a state of the MEA before the thermo-compression bonding. Carbon particles 34 and 36, which carry the metal catalysts of the anode-side and cathode-side catalyst layers, exist between a polymer electrolyte membrane 31 and carbon fibers 33 and 35 constituting the anode-side and cathode-side gas diffusion layers. FIG. 3B illustrates a state of the MEA after the thermo-compression bonding. The thickness of the polymer electrolyte membrane 31 is reduced to almost the same as that of a polymer electrolyte particle 32 having a higher modulus of elasticity. Also, carbon fibers 33 and 35 are so close to particle 32 as to almost contact it.

As illustrated in FIG. 3B, due to the thermo-compression bonding, the carbon fibers 33 and 35, the carbon particles 34 and 36, and the softened polymer electrolyte membrane 31 form a three-phase interface, which increases the effective reaction surface area of the MEA in the same manner as illustrated in FIG. 2B. In the MEA of Embodiment 2, the spacer portion also has proton conductivity. It is thus possible to increase the operating voltage of the polymer electrolyte fuel cell comprising this MEA.

The polymer electrolyte membrane portion having a higher modulus of elasticity is produced, for example, as follows. A solution is prepared by dissolving a polymerizable multi-functional monomer and a polymer electrolyte in an organic solvent, water, or a mixture of water and solvent at concentrations of about 0.1 to about 10 wt % of monomer and about 5 to about 20 wt % of polymer electrolyte, respectively. This solution is applied onto a polymer electrolyte membrane having a lower modulus of elasticity and is exposed to heat or ultraviolet rays for cross-linking polymerization. Examples of the multi-functional monomer capable of thermal polymerization or photo polymerization (i.e., the cross-linkable monomer) include ethylene glycol dimethacrylate, diethylene glycol dimethacrylate, triethylene glycol dimethacrylate, neopentyl glycol dimethacrylate, propylene ethylene glycol dimethacrylte, 1,4-butanediol dimethacrylate, 1,3-butanediol dimethacrylate, 1,6-hexanediol dimethacrylate, 1,9-nonanediol dimethacrylate, 1,10-decanediol dimethacrylate, trimethylolpropane trimethacrylate, glycerol dimethacrylate, 2-hydroxy-3-(acryloyloxy)propyl methacrylate, triethylene glycol diacrylate, propylene ethylene glycol diacrylate, 1,6-hexanediol diacrylate, 1,9-nonanediol diacrylate, dimethylol tri-cyclodecane diacrylte, trimethylol propane triacrylate, pentaerythritol triacrylate, neopentylglycol hydroxypivalate diacrylate, polytetramethylene glycol diacrylate and ditrimethylolpropane tetraacrylate.

### Embodiment 3

A first manufacturing method of an electrolyte membrane-electrode assembly in accordance with the present invention is described. This manufacturing method has an advantage of manufacturing, by a quite simple process, an MEA in which electronically insulating particles serving as spacers are interposed between the anode and the cathode.

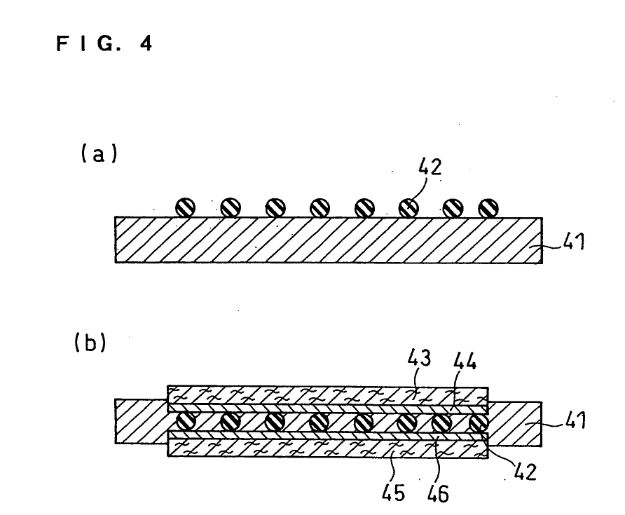

FIGS. 4A and 4B illustrate a manufacturing process of an MEA. However, the projections on the gas diffusion layers are omitted from this figure.

First, as illustrated in FIG. 4A, electronically insulating particles 42 are evenly scattered over a polymer electrolyte membrane 41. Subsequently, an anode-side catalyst layer 44 and a cathode-side catalyst layer 46 are formed on respective sides of the polymer electrolyte membrane 41 by a transfer method. To respective sides of the resultant polymer electrolyte membrane with the catalyst layers, an anode-side gas diffusion layer 43 and a cathode-side gas diffusion layer 45 are bonded under pressure. In this way, an MEA is produced having electronically insulating particles 42 interposed as spacers between the anode and the cathode, as illustrated in FIG. 4B. In the compression bonding step, thermo-compression bonding is preferably performed by hot rollers, a hot press or the like.

In scattering the particles 42, it is preferable to prevent the particles from scattering beyond the region of the polymer electrolyte membrane contacting the gas diffusion layers. For this, it is preferable to employ a method of placing a metal mask having a window, which is as large as the gas diffusion layer, on the polymer electrolyte membrane and scattering the particles. If many particles are present in the region not contacting the gas diffusion layers (i.e., the periphery of the polymer electrolyte membrane), the adhesion of the gaskets to the polymer electrolyte membrane may become weak, thereby impairing the gas tightness.

### Embodiment 4

A second manufacturing method of an MEA in accordance with the present invention is described.

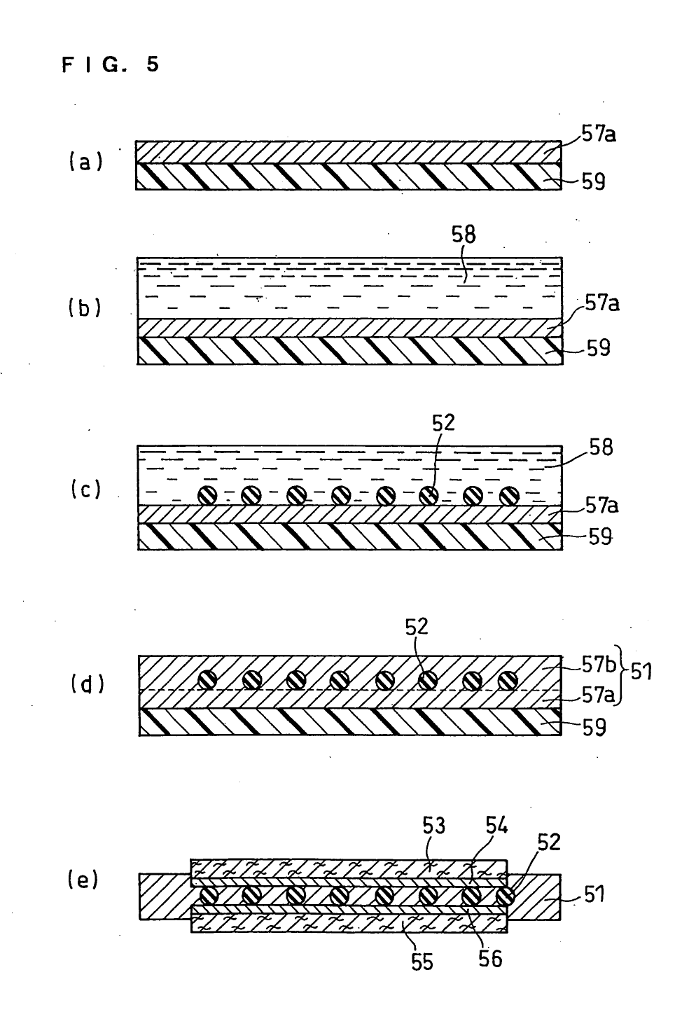

FIGS. 5A-5E illustrate a manufacturing process of the MEA. However, the projections on the gas diffusion layers are omitted. First, as illustrated in FIG. 5A, a first polymer electrolyte membrane 57a is formed on a substrate 59 by a casting method. Subsequently, a polymer electrolyte solution 58 is applied onto the polymer electrolyte membrane 57a, as illustrated in FIG. 5B. Then, as illustrated in FIG. 5C, before the applied polymer electrolyte solution 58 dries, electronically insulating particles 52 are evenly scattered over the applied surface and allowed to sink. Thereafter, the applied polymer electrolyte solution 58 is dried to remove the solvent. As a result, as illustrated in FIG. 5D, a second polymer electrolyte membrane 57b is formed on the first polymer electrolyte membrane 57a. Accordingly, a composite polymer electrolyte membrane 51 having the scattered particles 52 in the intermediate layer is formed.

On respective sides of the composite polymer electrolyte membrane 51, an anode-side catalyst layer 54 and a cathode-side catalyst layer 56 are formed, in the same manner as in FIGS. 4A and 4B. Then, an anode-side gas diffusion layer 53 and a cathode-side gas diffusion layer 55 are bonded under pressure to respective sides thereof. In this way, as illustrated in FIG. 5E, an MEA in which the electronically insulating particles 52 are interposed as the spacers between the anode and the cathode is produced. In the compression bonding step, thermo-compression bonding is preferably performed by hot rollers, a hot press or the like.

### Embodiment 5

A third manufacturing method of an MEA in accordance with the present invention is described.

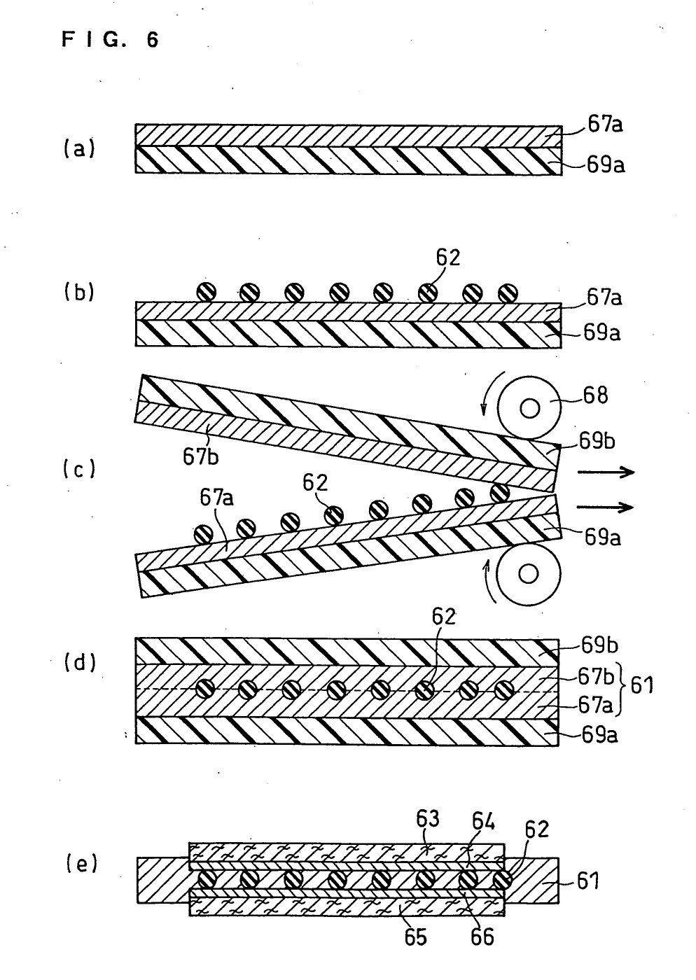

FIGS. 6A-6E illustrate a manufacturing process of the MEA. However, the projections on the gas diffusion layers are omitted. First, as illustrated in FIG. 6A, a first polymer electrolyte membrane 67a is formed on a substrate 69a by a casting method. Subsequently, as illustrated in FIG. 6B, electronically insulating particles 62 are scattered over the first polymer electrolyte membrane 67a. Then, as illustrated in FIG. 6C, a second polymer electrolyte membrane 67b formed on another substrate 69b, by a casting method, is placed on the face of the first polymer electrolyte membrane 67a on which the particles 62 are scattered, and the two membranes are bonded together under pressure by hot rollers 68. Accordingly, as illustrated in FIG. 6D, the first and second polymer electrolyte membranes 67a and 67b are joined together, to form a composite polymer electrolyte membrane 61 in which the particles 62 are intermediately dispersed. On respective sides of the composite polymer electrolyte membrane 61, an anode-side catalyst layer 64 and a cathode-side catalyst layer 66 are formed in the same manner as in FIG. 4. Then, an anode-side gas diffusion layer 63 and a cathode-side gas diffusion layer 65 are bonded under pressure. In this way, as illustrated in FIG. 6E, an MEA is produced having electronically insulating particles 62 interposed as spacers between the anode and the cathode.

### Embodiment 6

A fourth manufacturing method of an MEA in accordance with the present invention is described.

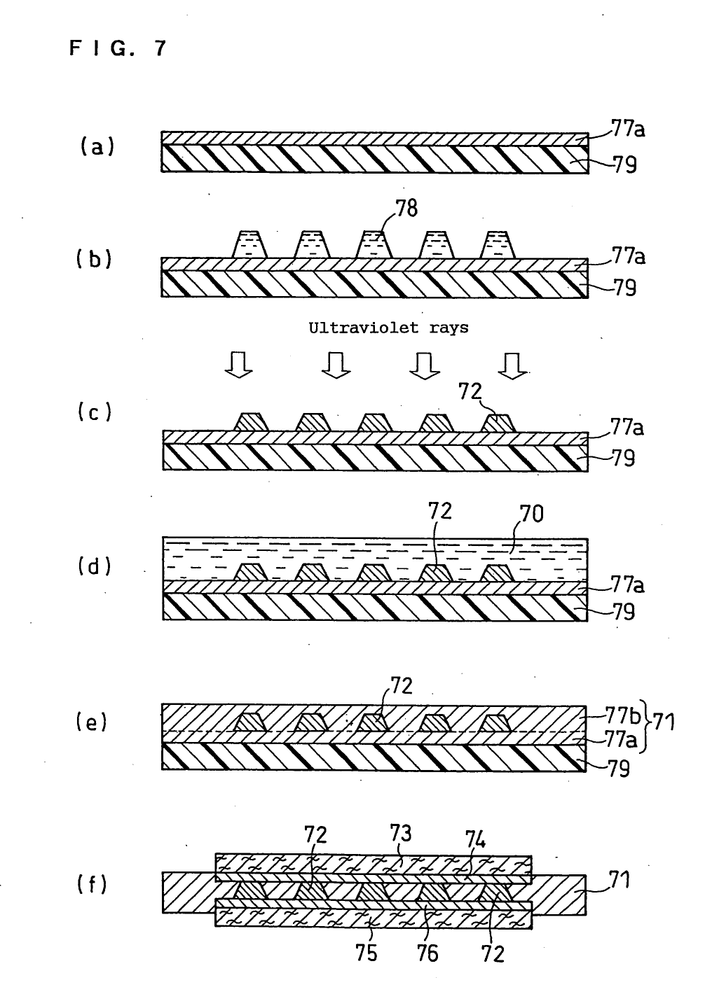

FIGS. 7A-7F illustrate a manufacturing process of the MEA. However, the projections on the gas diffusion layers are omitted. First, as illustrated in FIG. 7A, a first polymer electrolyte membrane 77a is formed on a substrate 79 by a casting method. Subsequently, as illustrated in FIG. 7B, a polymer electrolyte solution 78 containing a multi-functional monomer is applied onto the first polymer electrolyte membrane 77a, such that the solution is scattered in an island pattern. Then, as illustrated in FIG. 7C, the surface onto which the solution 78 is applied is irradiated with ultraviolet rays to cure the solution. In this way, particles or pieces 72 comprising a polymer electrolyte having a higher modulus of elasticity are formed in an island form.

Thereafter, as illustrated in FIG. 7D, a polymer electrolyte solution 70 is applied onto the surface on which the particles 72 are formed and dried to form a second polymer electrolyte membrane 77b. By this process, as illustrated in FIG. 7E, a composite polymer electrolyte membrane 71 is formed with the polymer electrolyte particles 72, having a higher modulus of elasticity, scattered in an intermediate layer. In the same manner as in FIGS. 4A and 4B, an anode-side catalyst layer 74 and a cathode-side catalyst layer 76 are formed on respective sides of the composite polymer electrolyte membrane 71, and an anode-side gas diffusion layer 73 and a cathode-side gas diffusion layer 75 are bonded under pressure to respective sides thereof. In this way, as illustrated in FIG. 7F, an MEA is produced in which the cured polymer electrolyte particles or pieces are interposed as the spacers between the anode and the cathode.

In the respective foregoing manufacturing processes, the catalyst layers are formed on the polymer electrolyte membrane by a transfer method and the gas diffusion layers are bonded to the catalyst layers under pressure. It is also possible, in the manufacturing methods of the present invention, to form a catalyst layer on each gas diffusion layer and bond the resultant anode and cathode to both sides of a polymer electrolyte membrane. Alternatively, it is possible to form catalyst layers by applying a catalyst paste onto a polymer electrolyte membrane by printing or the like and bonding gas diffusion layers to the catalyst layers.

In the compression bonding step of the respective foregoing manufacturing processes, a hot pressing device, hot rollers or the like may be used. Upon the thermo-compression bonding, the pressure is preferably about 20 to about 50 kilograms/square centimeter (kg/cm²), and the temperature is preferably about 120 to about 160° C.

### EXAMPLE 1

According to the manufacturing process as illustrated in FIG. 4, an MEA was produced.

30 milliliters (ml) of an ethanol solution containing 7 weight % of a polymer electrolyte (FLEMION™) was introduced into a 20 cm diameter petri dish and allowed to stand all day and night. It was then dried at 130° C. for 30 minutes to form the polymer electrolyte membrane 41, having a thickness of 30 μm, by a casting method. On this polymer electrolyte membrane 41 was placed a metal mask having a 6 cm×6 cm square window. This was covered with a hollow hemispheric container, of about 50 cm in diameter, made of acrylic resin. A small number of epoxy resin particles (MICROPEARL™ manufactured by Sekisui Chemical Co., Ltd.) of 20 μm in diameter were sprayed, as the electrically insulating particles 42, with a dry nitrogen gas from a hole located in the top of the container. The particles 42 were then evenly scattered over the polymer electrolyte membrane 41.

Subsequently, a catalyst paste was applied onto a substrate of polypropylene film (manufactured by Toray Industries, Inc.), having a thickness of 50 μm, with a bar coater and dried at room temperature. Thereafter, it was cut into a square of 6 cm×6 cm to form a catalyst layer with the substrate. The platinum content of this catalyst layer was approximately 0.2 milligrams/square centimeter (mg/cm²). The catalyst paste was prepared by adding 15 cubic centimeters (cc) of distilled water to 5.0 grams (g) of a carbon powder carrying a platinum catalyst, adding to it 25.0 g of an ethanol solution containing 9% by weight of a polymer electrolyte (FLEMION™), and stirring the mixture with a stirrer while applying ultrasonic vibration thereto for one hour.

Then, the catalyst layer with the substrate was placed on the region of the polymer electrolyte membrane 41 sprayed with the particles 42, and a similar catalyst layer was placed on the other side of the polymer electrolyte membrane 41. The combined polymer electrolyte membrane 41 and catalyst layers were sandwiched between polytetrafluoroethylene sheets and then heat-resistant rubber sheets and pressed by a hot pressing device under the conditions of a pressure of 40 kg/cm² and a temperature of 135° C. so that the catalyst layers 44 and 46 were transferred to both sides of the polymer electrolyte membrane 41. Thereafter, the substrates were peeled therefrom.

The gas diffusion layers 43 and 45 were placed on both sides of the polymer electrolyte membrane with the catalyst layers thus formed, and this was sandwiched between polytetrafluoroethylene sheets and pressed by a hot pressing device at 135° C. to produce an MEA. The interval between the anode-side catalyst layer 44 and the cathode-side catalyst layer 46 of the MEA thus produced was 18 to 20 μm, and this interval was also even in that the interval varied only slightly between 18 and 20 μm for each MEA produced in this manner. The gas diffusion layers 43 and 45 were prepared by immersing a carbon paper (manufactured by Toray Industries, Inc.) in an aqueous dispersion of fluorocarbon resin (ND-11 manufactured by Daikin Industries, Ltd.) and thereafter baking them at 300° C.

### COMPARATIVE EXAMPLE 1

An MEA was produced in the same manner as in Example 1 except that the epoxy resin particles were not sprayed over the polymer electrolyte membrane. However, the pressure applied by a hot pressing device in the compression bonding step was lower by 30% than that of Example 1 in order to prevent the contact of the anode and the cathode caused by the breaking of the polymer electrolyte membrane. The interval between the anode-side catalyst layer and the cathode-side catalyst layer of the produced MEA was 24 to 28 μm.

### EXAMPLE 2

According to the manufacturing process illustrated in FIG. 5, an MEA was produced. An ethanol solution containing 7% by weight of a polymer electrolyte (FLEMION™) was applied onto the substrate 59 of a polypropylene film (Toray Industries, Inc.), having a thickness of 50 μm, with a mini dye coater and allowed to stand at room temperature. It was then dried at 130° C. for 10 minutes to form the polymer electrolyte membrane 57a having a thickness of 5 μm. Subsequently, an ethanol solution containing 7% by weight of a polymer electrolyte (FLEMION™) was applied as the polymer electrolyte solution 58 onto the polymer electrolyte membrane 57a with a mini dye coater. The same electrically insulating particles 52 as those of Example 1 were evenly sprayed on the applied surface immediately after the application. Subsequently, this was allowed to stand at room temperature and then dried at 130° C. for 30 minutes to form the composite polymer electrolyte membrane 51 having a thickness of 30 μm.

Thereafter, in the same manner as in Example 1, the catalyst layers 54 and 56 were transferred to both sides of the composite polymer electrolyte membrane 51, the gas diffusion layers 53 and 55 were placed on the outer faces of the catalyst layers 54 and 56, respectively, and this was pressed to produce an MEA. The interval between the anode-side catalyst layer 54 and the cathode-side catalyst layer 56 was 18 to 20 μm, and this interval was also even.

### EXAMPLE 3

According to the manufacturing process illustrated in FIG. 7, an MEA was produced. In the same manner as in Example 2, the polymer electrolyte membrane 77a having a thickness of 5 μm was formed on the substrate 79, and the composite polymer electrolyte solution 78 was screen printed on the polymer electrolyte membrane 77a with a printing plate having a 1-mm-square mosaic pattern. As the composite polymer electrolyte solution 78, an ethanol solution containing a polymer electrolyte (FLEMION™), a cross-linkable monomer (1,6-hexane diol diacrylate), and a UV polymerization initiator (DAROCURE 1173™ manufactured by Ciba-Geigy Japan Ltd.) at concentrations of 9%, 2%, and 0.1% by weight, respectively, was used.

The composite polymer electrolyte solution 78 printed on the polymer electrolyte membrane 77a was dried at room temperature, and the printed surface was then radiated with ultraviolet rays by a high-pressure mercury lamp at 100 milli-Watts/square centimeter (mW/cm²) for 60 seconds and dried at 130° C. for 30 minutes. As a result, the monomer in the printed composite polymer electrolyte solution 78 became cross-linked and polymerized, forming the cured polymer electrolyte particles or pieces having a higher modulus of elasticity. Subsequently, an ethanol solution containing 7% by weight of a polymer electrolyte (FLEMION™) was applied onto the surface of the polymer electrolyte membrane 77a having the particles or pieces 72, allowed to stand at room temperature, and dried at 130° C. for 30 minutes, to form the composite polymer electrolyte membrane 71 having a thickness of 30 μm.

Thereafter, in the same manner as in Example 1, the catalyst layers 74 and 76 were transferred to both sides of the composite polymer electrolyte membrane 71, and the gas diffusion layers were bonded under pressure to produce an MEA. The interval between the anode-side catalyst layer 74 and the cathode-side catalyst layer 76 was 20 to 22 μm, and this interval was also even.

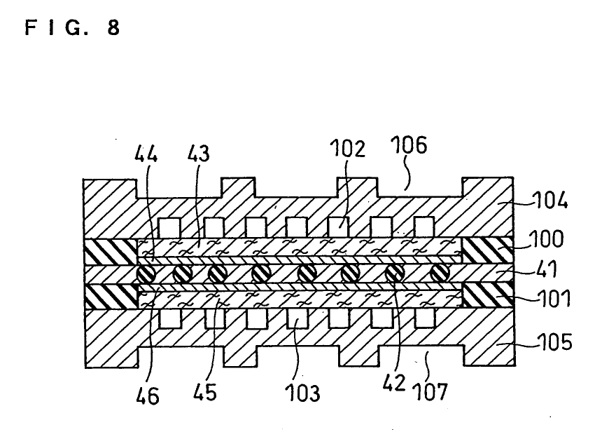

Using the MEAs of Examples 1 to 3 and Comparative Example 1, unit cells were fabricated. FIG. 8 illustrates such a typical example and is a sectional view of a unit cell using the MEA of Example 1. First, gaskets 100 and 101 were bonded to both sides of the periphery of the MEA's polymer electrolyte membrane 41 by applying heat and pressure thereto, to form the MEA with the gaskets. Separator plates 104 and 105 having an anode-side gas flow channel 102 and a cathode-side gas flow channel 103, respectively, were joined to the outer faces of the gas diffusion layers 43 and 45. Cooling water flow channels 106 and 107 were provided on the outer faces of the separator plates 104 and 105.

While the respective unit cells thus produced were kept at a temperature of 75° C., a hydrogen gas heated and humidified to a dew point of 70° C. was supplied to the anode side and air heated and humidified to a dew point of 30° C. was supplied to the cathode side. These unit cells were operated under the conditions of 70% hydrogen utilization rate and 40% oxygen utilization rate, and the relationship between the discharge current density and the cell voltage was examined. FIG. 13 shows the results.

FIG. 13 indicates that the cells of Examples 1 to 3 exhibit similarly good characteristics although they were operated under a rather dry condition. On the other hand, the cell of Comparative Example 1 exhibited lower cell voltages than those of Examples 1 to 3.

Also, the cross sections of the MEAs were observed. In the cell of Comparative Example 1, the interval between the anode and the cathode was 24 to 28 μm, which is greater than those of Examples 1 to 3, and it was therefore confirmed that the thickness of the electrolyte membrane was greater. It is believed that this greater thickness caused an increase in the internal resistance of the cell of Comparative Example 1, resulting in a decrease in cell voltage. Also, the cell of Comparative Example 1 was found to have some very thin portions where the interval between the electrodes was locally 10 μm. Therefore,, it was determined there was a danger that the polymer electrolyte membrane might break, bringing the anode in contact with the cathode, depending on the balance of the pressure applied during the thermo-compression bonding.

### Embodiment 7

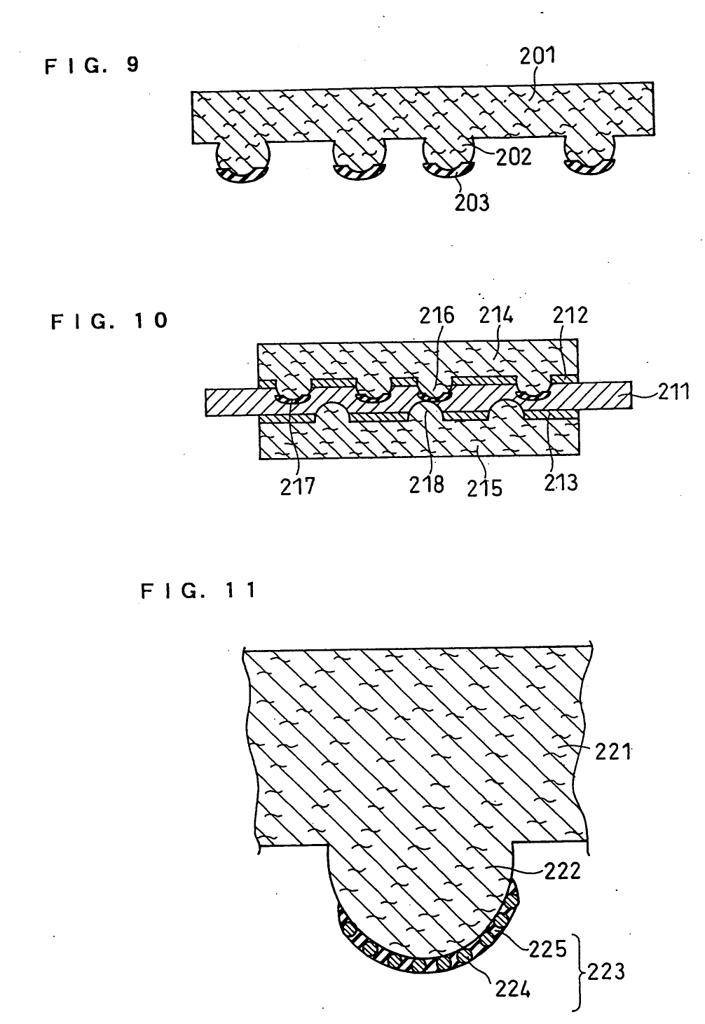

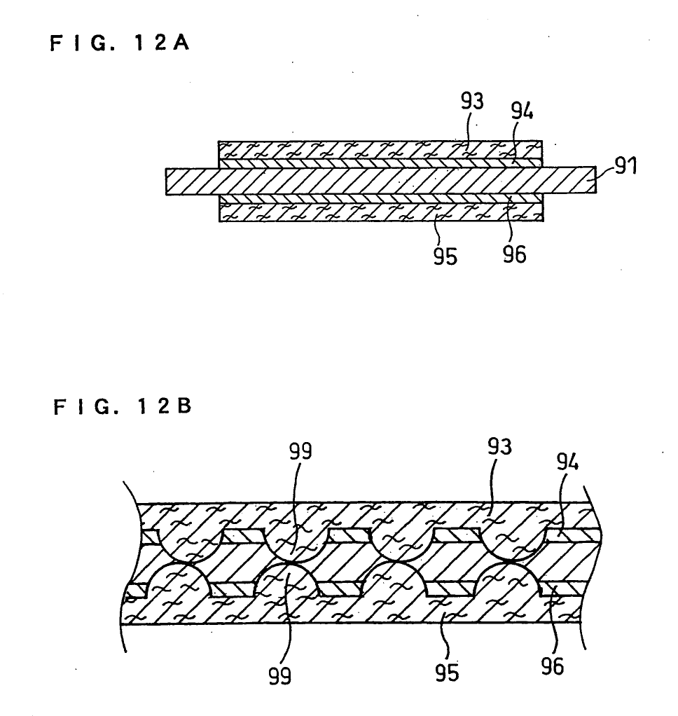

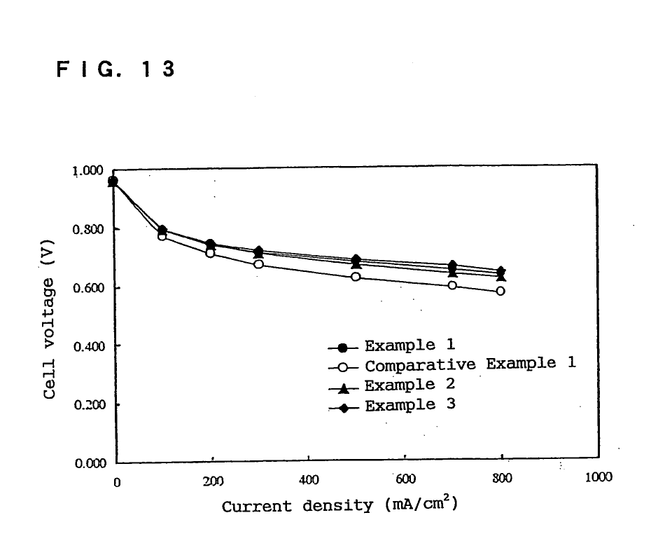

FIG. 9 is a schematic sectional view of the main part of a gas diffusion layer 201 whose projections 202 are coated with an electronically insulating layer 203.

Electronically insulating layer 203 is formed on the top faces of projections 202 on the surface of gas diffusion layer 201 made of a porous carbon material.

FIG. 10 is a schematic sectional view of an MEA comprising a gas diffusion layer 214 on which the above-mentioned electronically insulating layer 217 is formed. An anode-side catalyst layer 212 and a cathode-side catalyst layer 213 are joined to both sides of a polymer electrolyte membrane 211. An anode-side gas diffusion layer 214 and a cathode-side gas diffusion layer 215 are joined to the outer faces of the catalyst layers.

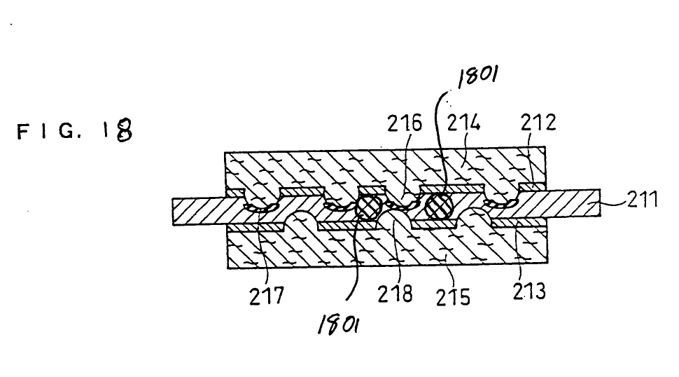

In FIG. 10, an electronically insulating layer 217 is formed only on the top faces of projections 216 on the surface of the anode-side gas diffusion layer 214. When the projections 216 penetrate the anode-side catalyst layer 212 and the polymer electrolyte membrane 211-and come in physical contact with projections 218 on the surface of the cathode-side gas diffusion layer 215, the electronically insulating layer 217 prevents the direct electrical contact of the projections 216 with the cathode-side gas diffusion layer 215, so that an internal short circuit does not occur. FIG. 18 illustrates the embodiment of FIG. 10 with electronically insulating members (for example, particles) 1801 serving as spacers for separating the gas diffusion layers 214, 215.

The electronically insulating layer may take, for example, the form of a dot, line, plane or dome, depending on the shape of the projections on the surface of the gas diffusion layer. Also, powdery insulating particles may be attached to the projections.

The electronically insulating layer must not be destroyed upon the contact of the projections with the polymer electrolyte membrane and the opposite electrode, during the thermo-compression bonding in the manufacturing process of the MEA. It is therefore preferable to select, for the insulating layer, a material having high hardness, particularly when the electronically insulating layer is thin.

As the inorganic material for forming the electronically insulating layer, glass, ceramic, and minerals such as mica and various inorganic crystals may be used. Among them, materials that are stable in an electrochemically corrosive atmosphere, for example, inorganic compounds such as silicon nitride and inorganic oxides such as silicon oxide, alumina and titanium oxide, are particularly preferable. A layer comprising such an inorganic insulating material is formed, for example, by applying onto the projections a mixed application liquid comprising such inorganic insulating particles and a polymerizable resin material or a mixed application solution comprising such inorganic insulating particles, a polymerizable resin material and a dispersion medium having low vapor pressure at room temperature such as alcohols, glycols, glycerin, ketons, or hydrocarbons, and then drying.

As the resin material for forming the electronically insulating layer, it is possible to use resins which are originally fluid or liquid and form cross-links to cause an increase in modulus of elasticity when heated or radiated with ultraviolet rays or radioactive rays. As such resins, the multi-functional monomers capable of thermal or ultraviolet polymerization listed in Embodiment 2 are used.

Although these polymerizable resins may be applied singly to the projections, it is more preferable to mix them with the particles of the above-mentioned inorganic insulating material, such as silicone nitride, silicon oxide or alumina to further increase the electrical insulating property of the electronically insulating layer. The applied polymerizable resin can be cured by heating it, radiating it with ultraviolet rays or radioactive rays, or the like during the thermo-compression bonding or fabrication step. The above-described method of curing the polymerizable resin after its application is also preferable from the viewpoint of production.

FIG. 11 schematically illustrates an electronically insulating layer 223 formed on projections 222 on the surface of a gas diffusion layer 221. The layer 223 comprises an inorganic insulating material 224 and a polymer resin 225.

A resin material other than the polymerizable resins may be mixed with an inorganic insulating material for use. In addition, it is also possible to use resins, such as rubber and ebonite, various insulating materials, such as dietary fiber, proton conductive resins whose modulus of elasticity is increased by cross-linking or the like, cross-linked cation-exchange resins having proton conductivity, and the like as the materials for forming the electronically insulating layer.

A first method for forming an electronically insulating layer on projections on the surface of a gas diffusion layer includes the following steps. An electronically insulating layer is formed on a substrate, comprising a film of polypropylene, polyethylene terephthalate or the like. The electronically insulating layer is placed on one face of the gas diffusion layer, and the electronically insulating layer is transferred to the projections on the surface of the gas diffusion layer by compression bonding, roller pressing or the like. According to this method, the electronically insulating layer can be formed on the projections present on the surface of the gas diffusion layer facing the polymer electrolyte membrane.

The electronically insulating layer can be formed by applying, for example, a mixture of a fluid or liquid resin material and an inorganic electronically insulating material, or a dispersion of inorganic particles in a dispersion medium (these are generically named coating material), onto a substrate with a dye coater or the like and drying or curing it. As the transfer method, there is a method of drying or curing the applied layer on the substrate to form an electronically insulating layer and transferring it to the gas diffusion layer. It is also possible to employ a method of transferring the applied layer, while it is uncured, to the gas diffusion layer and curing the applied layer in a subsequent step, to form an electronically insulating layer.

A second method for forming an electronically insulating layer on projections on the surface of a gas diffusion layer includes the following steps. The above-mentioned coating material containing an electronically insulating material is applied onto projections on the surface of a gas diffusion layer on which a catalyst layer is to be formed. The coating material is then cured by drying it, heating it, or radiating it with of ultraviolet rays or radioactive rays. As the method for applying the coating material, it is preferable to employ, for example, a printing method using a thick metal mask and a doctor blade, whose blade position is set high. According to this method, the coating material can be applied onto the projections on the surface of the gas diffusion layer.

Both of the above methods can effectively prevent the adhesion of the electronically insulating layer to the parts of the gas diffusion layer other than the projections.

### EXAMPLE 4

30 ml of an ethanol solution containing 7% by weight of a polymer electrolyte (FLEMION™) was introduced into a petri dish of 20 cm in diameter and allowed to stand all day and night. It was then dried at 130° C. for 30 minutes to form a cast membrane of the polymer electrolyte having a thickness of 30 μm.

Subsequently, 50% by weight of a platinum catalyst having an average particle size of 2 nanometers (nm) was carried on carbon particles (KETJEN BLACK EC™ manufactured by Ketjen Black International Company) having an average particle size of 30 nm. A catalyst paste was prepared by adding 15 cc of distilled water to 5.0 g of this catalyst-carrying carbon powder, adding to it 25.0 g of an ethanol solution containing 9% by weight of a polymer electrolyte (FLEMION™), and stirring the mixture with a stirrer while applying ultrasonic vibration thereto for one hour. This catalyst paste was applied onto a substrate of a polypropylene film (manufactured by Toray Industries, Inc.) having a thickness of 50 μm with a bar coater and dried at room temperature. It was then cut into a square of 6 cm×6 cm to form the substrate with a catalyst layer. The platinum content of the catalyst layer was approximately 0.2 mg/cm².

Thereafter, the polypropylene film with the catalyst layer was placed on one side of the above-described polymer electrolyte membrane such that the catalyst layer faced inward. A similarly produced polypropylene film with a catalyst layer was similarly placed on the other side of the polymer electrolyte membrane. The combined structure was sandwiched between polytetrafluoroethylene sheets and then heat-resistant rubber sheets and pressed by a hot pressing device at 135° C. Thereafter, the polypropylene film was peeled from the catalyst layers. In this way, the catalyst layer was formed on each side of the polymer electrolyte membrane by a transfer method.

On the other hand, a carbon cloth of approximately 400 μm in thickness (CARBOLON GF-20-31E™ manufactured by Nippon Carbon Co., Ltd.) was immersed in an aqueous dispersion of fluorocarbon resin (ND-1™ manufactured by Daikin Industries, Ltd.) and baked at 300° C. to make it water repellent. A coating material paste containing an insulating material was printed on the carbon cloth. Subsequently, the printed coating material was radiated with ultraviolet rays by a high-pressure mercury lamp at 100 mW for 120 seconds to cross-link and cure the polymerizable monomer in the coating material. In this way, a gas diffusion layer comprising the water-repellent carbon cloth whose projections on the surface were coated with an insulating layer was obtained.

The coating material was prepared by mixing silica particles having a size of approximately 30 nm (AEROSIL #50™ manufactured by Nippon Aerosil Co., Ltd.), ethylene glycol dimethacrylate (manufactured by Kyoeisha Chemical Co., Ltd) which is a polymerizable monomer, and a photo polymerization initiator (DAROCURE™ manufactured by Ciba Specialty Chemicals Ltd.) in a weight ratio of 1:5:0.1. The coating material was printed, using a metal mask having a 0.3 mm square window and a doctor blade. The blade height of the doctor blade was adjusted while checking with a microscope that the paste was applied onto only the projections on the surface of the carbon cloth.

The polymer electrolyte membrane with the catalyst layers produced in the above manner was sandwiched between the gas diffusion layers, such that the insulating layers faced inward, and this was sandwiched between polytetrafluoroethylene sheets and pressed by a hot pressing device at 135° C. to produce an MEA.

### COMPARATIVE EXAMPLE 2

A carbon cloth of approximately 400 μm in thickness (CARBOLON GF-20-31E™ manufactured by Nippon Carbon Co., Ltd.) was immersed in an aqueous dispersion of fluorocarbon resin (ND-1™ manufactured by Daikin Industries, Ltd.) and baked at 300° C. to make it water repellent. Except that this was used as the gas diffusion layer just as it was, an MEA was produced in the same manner as in Example 4.

Using the MEAs of Example 4 and Comparative Example 2, unit cells were fabricated in the same manner as in Example 1.

While the respective unit cells were kept at 75° C., a hydrogen gas heated and humidified to a dew point of 70° C. was supplied to the anode side and air heated and humidified to a dew point of 70° C. was supplied to the cathode side. These unit cells were operated under the conditions of 70% hydrogen utilization rate and 40% air utilization rate, and the voltages of the unit cells with no load were examined. As a result, the voltage of the cell of Example 4 was 0.99 V, while the voltage of the cell of Comparative Example 2 was 0.88 V. Accordingly, it was confirmed that although the unit cell of Comparative Example 2 caused a short circuit between the gas diffusion layers, the unit cell of Example 4 was effectively prevented from causing an internal short circuit.

Of each of the above-mentioned unit cells, 100 cells were stacked to form a cell stack. A stainless steel current collector plate, an insulator plate and an end plate were joined to each end of the cell stack, and the resultant stack was secured by clamping rods. The clamping pressure was 15 kgf/cm² per separator area. Each of the cell stacks was continuously operated for 1,000 hours under the same conditions as those of the above-mentioned unit cells, and the change in open-circuit voltage during the continuous operation was examined. As a result, the average drop in cell voltage per unit cell was as small as 2 mV in Example 4, whereas the voltage drop was as large as 50 mV in Comparative Example 2. Accordingly, it was confirmed that the cell stacks of the examples of the present invention had high reliability and durability and were prevented from causing an internal short circuit.

The present invention can provide an MEA which is free from a short circuit between electrodes and has low internal resistance and large effective reaction surface area. The use of this MEA enables production of a polymer fuel cell with high reliability.

The foregoing description and examples have been presented for purposes of illustration. They are not intended to be exhaustive or to limit the invention to the precise form disclosed. Hence, many modifications and variations are possible in light of the above teaching without departing from the broad inventive concept thereof. It is understood, therefore, that this invention is not limited to the particular embodiments disclosed, but it is intended to cover modifications within the spirit and scope of the present invention as defined by the appended claims.

This application is based on Japanese Patent Application No. 2002-084375 filed on Mar. 25, 2002 and Japanese Patent Application No. 2002-228319 filed on Aug. 6, 2002 and PCT/JP03/03479 filed Mar. 20, 2003, the entire technical contents of which are expressly incorporated by reference herein.

What is claimed is:

1. A polymer electrolyte membrane-electrode assembly for a fuel cell comprising:
a first electrode and a second electrode; and
a polymer electrolyte membrane interposed between said first and second electrodes,
wherein each of said first and second electrodes comprises a catalyst layer in contact with said polymer electrolyte membrane and a gas diffusion layer in contact with said catalyst layer, and
wherein said polymer electrolyte membrane comprises electronically insulating spacer members that separate the respective gas diffusion layers of the first and second electrodes.

2. The polymer electrolyte membrane-electrode assembly in accordance with claim 1, wherein said spacer members comprise an electrically insulating material.

3. The polymer electrolyte membrane-electrode assembly in accordance with claim 1, wherein said spacer members comprise a polymer electrolyte having a higher modulus of elasticity than a material of said polymer electrolyte membrane.

4. The polymer electrolyte membrane-electrode assembly in accordance with claim 1, wherein the gas diffusion layer of at least one of said first and second electrodes comprises projections on a surface that faces said polymer electrolyte membrane and an electronically insulating layer that coats said projections.

5. The polymer electrolyte membrane-electrode assembly in accordance with claim 4, wherein said insulating layer comprises an electrically insulating inorganic material and a polymer resin.

6. A method for manufacturing a polymer electrolyte membrane-electrode assembly for a fuel cell, comprising the steps of:
disposing electronically insulating particles over a face of a polymer electrolyte membrane;
providing a first electrode to said face of said polymer electrolyte membrane having said particles; and
providing a second electrode to another face of said polymer electrolyte membrane.

7. A method for manufacturing a polymer electrolyte membrane-electrode assembly for a fuel cell, comprising the steps of:
applying a polymer electrolyte solution onto a surface of a first polymer electrolyte membrane;
disposing electronically insulating particles on said surface applied with said polymer electrolyte solution;
drying said polymer electrolyte solution to form a composite polymer electrolyte membrane comprising the first polymer electrolyte membrane and a second polymer electrolyte membrane that contains said particles;
applying a first electrode to one face of said composite polymer electrolyte membrane; and
applying a second electrode to another face of said composite polymer electrolyte membrane.

8. A method for manufacturing a polymer electrolyte membrane-electrode assembly for a fuel cell, comprising the steps of:
disposing electronically insulating particles on a face of a first polymer electrolyte membrane;
layering a second polymer electrolyte membrane to said face of said first polymer electrolyte membrane having said particles to form a composite polymer electrolyte membrane;
applying a first electrode to one face of said composite polymer electrolyte membrane; and
applying a second electrode to another face of said composite polymer electrolyte membrane.

9. A method for manufacturing a polymer electrolyte membrane-electrode assembly for a fuel cell, comprising the steps of:
applying a solution containing a multi-functional monomer capable of thermal polymerization or photo polymerization and a polymer electrolyte in an island form to a face of a first polymer electrolyte membrane;
performing at least one of photo-irradiating and heating said solution applied to said face of said first polymer electrolyte membrane to form polymer electrolyte particles having a high modulus of elasticity on said first polymer electrolyte membrane;
applying a polymer electrolyte solution onto said face of said first polymer electrolyte membrane having said particles;
drying said applied polymer electrolyte solution to form a composite polymer electrolyte membrane comprising said first polymer electrolyte membrane and a second polymer electrolyte membrane that contains said particles; and
applying a first electrode to one face of said composite polymer electrolyte membrane; and
applying a second electrode to another face of said composite polymer electrolyte membrane.

10. A polymer electrolyte membrane electrode assembly for a fuel cell, comprising:
a polymer electrolyte membrane;
an anode-side electrode applied to a first face of the polymer electrolyte membrane;
a cathode-side electrode applied to a second face of the polymer electrolyte membrane that opposes the first face; and
a plurality of electronically insulating members disposed between the anode-side and cathode-side electrodes that separates the anode-side and cathode-side electrodes in a region of the electronically insulating members.

11. The polymer electrolyte membrane electrode assembly of claim 10, wherein the anode-side and cathode-side electrodes each comprise a catalyst layer.

12. The polymer electrolyte membrane electrode assembly of claim 10, wherein the electronically insulating members comprise an electrically conductive particle coated with an electrically insulating material.

13. The polymer electrolyte membrane electrode assembly of claim 10, wherein the electronically insulating members comprise a polymer electrolyte material having a higher modulus of elasticity than that of the polymer electrolyte membrane.

14. The polymer electrolyte membrane electrode assembly of claim 10, wherein the thicknesses of the electronically insulating members are in the range of about 5 to about 20 μm.

15 A polymer electrolyte membrane electrode assembly, comprising:
a polymer electrolyte membrane;
an anode-side electrode joined to a first face of the polymer electrolyte membrane;
a cathode-side electrode joined to a second face of the polymer electrolyte membrane that opposes the first face;
at least one of the anode-side and cathode-side electrodes comprises a gas diffusion layer having projections facing the polymer electrolyte membrane; and
an electronically insulating layer that is disposed between the anode-side and cathode-side electrodes that separates the anode-side and cathode-side electrodes in a region of the electronically insulating layer and that coats said projections facing the polymer electrolyte membrane.

16. The polymer electrolyte membrane electrode assembly of claim 15, wherein the electronically insulating layer comprises a polymer resin.

17. The polymer electrolyte membrane electrode assembly of claim 16, wherein the electronically insulating layer further comprises inorganic insulating material.

18. The polymer electrolyte membrane electrode assembly of claim 15, further comprising a plurality of electronically insulating members that are disposed between the anode-side and cathode-side electrodes and that separate the anode-side and cathode-side electrodes in a region of the electronically insulating members.

19. The polymer electrolyte membrane electrode assembly of claim 18, wherein the electronically insulating members are particles which have thicknesses in a range of about 5 μm to about 20 μm.

20. A method for manufacturing a polymer electrolyte membrane electrode assembly comprising a polymer electrolyte membrane, an anode-side electrode joined to a first face of the polymer electrolyte membrane, a cathode-side electrode joined to a second face of the polymer electrolyte membrane that opposes the first face, at least one of the anode-side and cathode-side electrodes comprises a gas diffusion layer having projections facing the polymer electrolyte membrane, and an electronically insulating layer that is disposed between the anode-side and cathode-side electrodes that separates the anode-side and cathode-side electrodes in a region of the electronically insulating layer and that coats said projections facing the polymer electrolyte membrane, said method comprising forming said electronically insulating layer on said projections by the steps of:
forming an electronically insulating film on a substrate;
placing said electronically insulating film formed on said substrate on one face of said gas diffusion layer; and
transferring said electronically insulating film to said projections on the surface of the gas diffusion layer.

21. The method according to claim 20, wherein said step of forming said electronically insulating film comprises coating a mixture of a fluid or liquid resin material and an inorganic electronically insulating material or a dispersion of inorganic particles in a dispersion medium onto said substrate.

22. The method according to claim 20, wherein said transferring step comprises drying or curing said electronically insulating and then transferring said electronically insulating film to said gas diffusion layer by compression bonding or roller pressing.

23. The method according to claim 20, wherein said transferring step comprises transferring said electronically insulating film to said gas diffusion layer by compression bonding or roller pressing and then drying or curing said electronically insulating film to provide said electronically insulating layer.

24. The method according to claim 20, wherein said substrate comprises a film of polypropylene or polyethylene terephthalate.

25. A method for manufacturing a polymer electrolyte membrane electrode assembly comprising a polymer electrolyte membrane, an anode-side electrode joined to a first face of the polymer electrolyte membrane, a cathode-side electrode joined to a second face of the polymer electrolyte membrane that opposes the first face, at least one of the anode-side and cathode-side electrodes comprises a gas diffusion layer having projections facing the polymer electrolyte membrane, and an electronically insulating layer that is disposed between the anode-side and cathode-side electrodes that separates the anode-side and cathode-side electrodes in a region of the electronically insulating layer and that coats said projections facing the polymer electrolyte membrane, said method comprising forming said electronically insulating layer on said projections by the steps of:
applying a coating material including an electronically insulating material on said projections; and
curing said coating material.

26. The method according to claim 25, wherein said applying step comprises a printing method using a thick metal mask and a doctor blade.

27. The method according to claim 25, wherein said curing step comprises drying said coating material, heating coating material, or radiating said coating material with ultraviolet rays or radioactive rays.

28. The method according to claim 25, wherein said coating material comprises a mixture of a fluid or liquid resin material and an inorganic electronically insulating material or a dispersion of inorganic particles in a dispersion medium onto said substrate.
